(19) United States
(12) Patent Application Publication
(10) Pub. No.: US 2007/0185624 A1
(43) Pub. Date: Aug. 9, 2007

(54) Method for remote reprogramming of vehicle flash memory

(75) Inventors: Douglas L. Duddles, Oxford, MI (US); Scott A. Mc Cullough, Sterling Heights, MI (US); James M. Kortge, Ferndale, MI (US); John J. Flood IV, Canton, MI (US); Huan T. Nguyen, Troy, MI (US)

Correspondence Address: James D. Stevens;Reising, Ethington, Barnes, Kisselle, P.C., P.O. Box 4390, Troy, MI, 48099-4390, US

(73) Assignee: General Motors Corporation, Detroit, MI (US)

(21) Appl. No.: 11/348,713

(22) Filed: Feb. 7, 2006

(51) Int. Cl. G01M 17/00

(52) U.S. Cl. 701/1; 701/33

(57) ABSTRACT

A system and method for managing remote reprogramming of flash memory in a vehicle electronic control unit. A vehicle state manager process is used to first determine if the vehicle conditions are suitable for reprogramming of a particular ECU and, if so, the vehicle state manager then maintains the proper vehicle configuration during the reprogramming operation. The system and method can be used to automatically reprogram a vehicle ECU using new programming received by digital satellite broadcast or other wireless transmission to the vehicle.

### TECHNICAL FIELD

The invention relates to onboard vehicle electronic control units (ECUs) and techniques for reprogramming of flash memories contained in the ECUs.

### BACKGROUND OF THE INVENTION

Automobiles today typically include a plurality of ECUs that perform various functions. This may include a body control module that controls, among other things, a vehicle ignition relay to enable switching on and off of the ignition by an operator via an ignition key switch. Other ECU modules includes such things as an engine controller, navigation system, diagnostic system, and the like. These ECUs will normally be connected together via a vehicle local area network (VLAN) which can be implemented as a serial bus using one or more network topologies and protocols known to those skilled in the art. Many if not all of these ECUs will contain a processor and flash memory that is used as firmware to provide programming (often low level base programming) for the module. This memory can also be used to store calibrations and other data used by the ECU in which it is located. For various reasons known to those skilled in the art, there are circumstances in which it is advantageous to be able to update or otherwise change the programming (i.e., the executable programs and/or data) in the flash memory by writing to at least a portion of the flash memory.

Currently, such reprogramming of the memory within a particular ECU is typically carried out by communicating with the ECU over the VLAN. During vehicle development, this may be performed by a number of tools, such as a development programming system application under control of a development engineer. During vehicle assembly, it may be performed automatically by the manufacturer. In a dealer service environment, reprogramming can be performed by a service programming system under control of a technician. In each of these cases, the new programming is typically provided via a separate computer or programming tool that physically connects to the vehicle and into the VLAN. Furthermore, in all of these reprogramming scenarios, the ECU to be programmed, as well as the entire vehicle, should first be placed and then maintained in a state amenable to programming. For example, for purposes of reprogramming, the manufacturer might specify the following as minimum requirements:
1. The battery voltage must be sufficient for programming of the ECU during the entire operation.
2. The engine must not be running.
3. The ignition switch must be in the RUN position.

The technician performing the programming must ensure that these conditions are correct before starting the programming task, and must maintain the conditions during programming; otherwise, the ECU may not be programmed successfully. For instance, switching off the ignition while programming will typically cause the operation to abort.

More recently, remote reflashing has been proposed as taught in U.S. Patent Application Publication No. 2005/0256614A1. The disclosed method involves determining a group of vehicles to be updated with new software, preparing and wirelessly transmitting a software update package to the group of vehicles, and then installing the software in at least one target ECU at the vehicles. The software update package can specify the vehicle state required as a pre-requisite to updating so that no update will occur if the vehicle is not in the proper state.

### SUMMARY OF THE INVENTION

In accordance with one aspect of the invention, there is provided a method of reprogramming firmware located in a first electronic control unit (ECU) located onboard a vehicle using new programming supplied to the vehicle, wherein the method comprises the steps of:
(a) receiving new programming via wireless transmission to the vehicle using a second ECU located onboard the vehicle;
(b) determining whether vehicle conditions are acceptable for reprogramming of the first ECU;
(c) if the vehicle conditions are acceptable, then sending the new programming to the first ECU and storing the new programming in firmware contained in the first ECU while holding certain vehicle conditions in their existing state.

Preferably, step (c) is carried out using a vehicle state manager program executing in a third ECU. For example, in one embodiment of the invention this third ECU can be operable under control of the vehicle state manager to ignore user inputs via an ignition key switch during reprogramming of the first ECU. Thus, for this embodiment, the ignition can be maintained in a predetermined state (e.g., RUN without the engine running) independently of ignition key switch position during storing of the new programming in the first ECU. The third ECU can, but need not be one that operates on the vehicle as a power mode master.

In accordance with another aspect of the invention, there is provided a method of reprogramming flash memory located in an electronic control unit onboard a vehicle using new programming supplied wirelessly from a remote location. For this purpose, the vehicle has a telematics unit that is coupled to the electronic control unit and that receives the new programming via a wireless communications network. The method of reprogramming the flash memory comprises the steps of:
(a) receiving new programming for the electronic control unit via wireless transmission from the wireless communications network to the vehicle's telematics unit;
(b) determining if a desired configuration of vehicle conditions exists on the vehicle;
(c) if the desired configuration exists, then carrying out a reprogramming process that includes:
   (c1) initiating a vehicle state hold by maintaining at least some controllable vehicle conditions in their current state and inhibiting changes to those controllable vehicle conditions until the reprogramming process is complete;
   (c2) sending the new programming to the electronic control unit; and
   (c3) replacing programming within the electronic control unit with the new programming; and thereafter
(d) terminating the vehicle state hold.

In accordance with yet another aspect of the invention, there is provided a method of reprogramming flash memory located in an electronic control unit onboard a vehicle using new programming supplied to the vehicle, wherein the method comprises the steps of:
(a) interacting with a vehicle operator via a user interface and instructing the vehicle operator to place the vehicle in a desired configuration;
(b) placing the vehicle in a vehicle hold state by electronically inhibiting changes to the desired configuration;
(c) storing new programming in flash memory contained in at least one vehicle electronic control unit; and thereafter
(d) removing the vehicle from the vehicle hold state and thereby permitting the vehicle configuration to be changed from the desired configuration.

### BRIEF DESCRIPTION OF THE DRAWINGS

Preferred exemplary embodiments of the invention will hereinafter be described in conjunction with the appended drawings, wherein like designations denote like elements, and wherein:

FIG. 1 is a block diagram showing a mobile vehicle, central facility, and communications systems for enabling wireless communication between the vehicle and central facility, and FIG. 1 further depicts salient portions the vehicle's network of ECUs, VLAN, and user interface that are used to implement an embodiment of the method of the invention; and

FIG. 2 is a flow chart of an embodiment of a remote flash memory reprogramming process of the present invention, which can be carried out using the system components of FIG. 1.

### DETAILED DESCRIPTION OF THE PREFERRED EMBODIMENTS

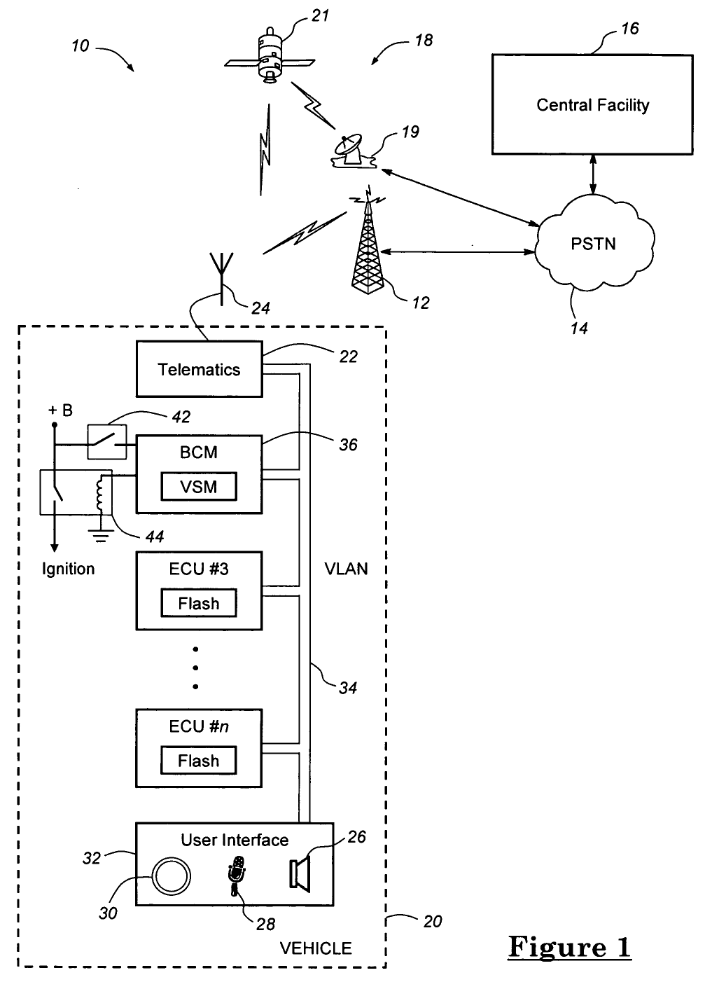

With reference to FIG. 1, there is shown a mobile vehicle communication system 10 which includes a conventional cellular communication network having a voice traffic channel that is used for two-way transmission of voice data between cellular telephones. The communication system 10 includes a cellular communication network 12 connected to a public switched telephone network 14 which together are used to provide voice and data communication between a passenger vehicle 20 and other remote locations such as a call center or other central facility 16. The cellular network 12 can be one that uses packetized cellular communication techniques such as the GSM (including UMTS) or CDMA (IS-95 or CDMA2000) standards. Communication system 10 also includes a second wireless communication system in the form of a digital satellite broadcast system 18 that utilizes a transmitting antenna 19 to send a data stream to a satellite 21 which then broadcasts the data stream for receipt by the vehicle 20.

Vehicle 20 has a telematics unit 22 and an associated user interface 32 that together are used to provide both wireless telephony services to the driver as well as automated voice interaction with the driver. Telematics unit 22 includes the components normally found in a cellular communication device, such as a CDMA compatible chipset, and this telematics unit 22 is connected to a vehicle antenna 24 that enables use of the cellular network 12 to permit a vehicle occupant to carry on voice conversations using a speaker 26 and microphone 28. These components of onboard system 22 can be implemented in a conventional manner, as will be known to those skilled in the art. Apart from the microphone 28 input, onboard system 22 also includes at least one pushbutton 30 that can be used to initiate a voice communication with a live advisor (not shown) located at the call center. The speaker, microphone, and pushbutton are all part of the vehicle user interface 32 which, again, is used not only to provide the driver with wireless telephony services, but also by the telematics unit 22 and/or other vehicle systems to interact with the driver. This latter feature of the disclosed embodiment will be discussed in greater detail below.

Telematics unit 22 and the user interface 32 are each implemented as electronic control units (ECUs) that communicate with each other via a vehicle local area network (VLAN) 34 which can be implemented in various known ways, such as by using a serial bus that passes data and control signals using a predefined protocol. Also connected to VLAN 34 are a number of other ECUs, including a body control module (BCM) 36 and other ECUs denoted generically as ECU #3 through ECU #n. These additional ECUs can be used for various vehicle purposes, as will be known to those skilled in the art. In this embodiment, each of the ECUs are microprocessor-based units that include flash memory which stores programming used by the ECU. This flash memory can be used to store all of the programming, or can be used to store just basic low level programming used by the ECU (e.g., at start up and for other basics of its operation), in which case the higher level functional programming can be stored in another memory that is accessible to the ECU.

In general, to update the flash memory in a particular ECU, new programming is transmitted from the central facility 16 to the vehicle by way of digital satellite broadcast from the satellite 21. The new programming can be sent over a specific satellite broadcast channel and is received by the telematics unit 22 either by antenna 24 or by way of a separate antenna (not shown) that receives the satellite broadcast transmissions. Any of a number of specific approaches to accomplish successful transmission of the new programming to the vehicle can be used. For example, the satellite transmission can be at a specified time with the telematics unit programmed to monitor for the transmission at that time. Alternatively, the satellite transmission can be sent repeatedly at spaced intervals in time with the telematics unit configured to monitor for the transmission whenever it is on and active. As another approach, the transmission can be initiated by a signal from the vehicle indicating it is prepared to receive the transmission of new programming. In any approach used, the successful receipt of the new programming can be reported back to the central facility 16 by the telematics unit 20 over the cellular network 12.

If desired, rather than using digital satellite transmission of new programming to the vehicle, the communication system 10 could also include the ability to utilize the cellular network 12 to provide new programming content to the vehicle, in which case the digital satellite broadcast system 18 would not be needed. For a packetized cellular communication system that is enabled for data communication with the vehicle, this programming can be sent via a data channel. Where only a voice channel is used, the programming can be sent as data over the voice channel using techniques known to those skilled in the art.

U.S. Patent Application Publication No. 2005/0256614A1 provides additional information concerning the preparing, transmission, and installation of updated software and, except as discussed below, that information is applicable to the illustrated embodiment. For example, the new programming can be associated with only certain vehicles using, for example, VIN numbers, and version numbers and version checking can be used to ensure that proper, compatible versions of new programming are used to update the ECUs. Accordingly, the complete disclosure contained in U.S. Patent Application Publication No. 2005/0256614A1 is hereby incorporated by reference.

There are various events that can result in aborted reflashes, partial reflashes, and other such problems, and this typically occurs if there is a loss of power (e.g., switching the ignition key to OFF) during reprogramming of an ECU's flash memory. Such problems can also occur if inputs to the ECU are changed during the reprogramming process (e.g., an ECU receives an input that causes an interrupt at which point the partially reprogrammed ECU attempts to execute a program routine). To prevent the occurrence of these problems, the body control module (BCM) 36 includes a vehicle state manager (VSM) 40 which is implemented as a program stored in memory. The VSM 40 works in conjunction with telematics unit 22 to control the installation of new programming into one or more flash memories that are located in a particular ECU. More specifically, as will be discussed below, VSM 40 handles both (1) the determination of whether the vehicle is in a proper configuration to allow reprogramming and (2) the control of various vehicle parameters to maintain the vehicle in the proper configuration until reprogramming is complete. In the illustrated embodiment, VSM 40 is resident on BCM 36 which is connected to receive the driver-controlled ignition key switch 42 as an input, and this ECU 36 controls operation of an ignition relay 44 to switch the vehicle ignition on and off. The switch 42 and relay 44 circuit arrangement shown is diagrammatic only and not intended to depict a complete ignition power control schematic. As is known by those skilled in the art, BCM 36 operates as the power mode master controlling the ignition power state (e.g., OFF, ACCESSORIES, RUN) using both the ignition key switch 42 input as well as other inputs to BCM 36. Under normal conditions, the driver can control the ignition power state using his or her ignition key, and BCM 36 will switch relay 42 on and off accordingly. However, this relay control of the ignition power allows BCM 36 to control the ignition power state independently of ignition key switch position when appropriate, and this feature of the ignition system is used by the VSM 40 during reprogramming, as will be discussed in greater detail below.

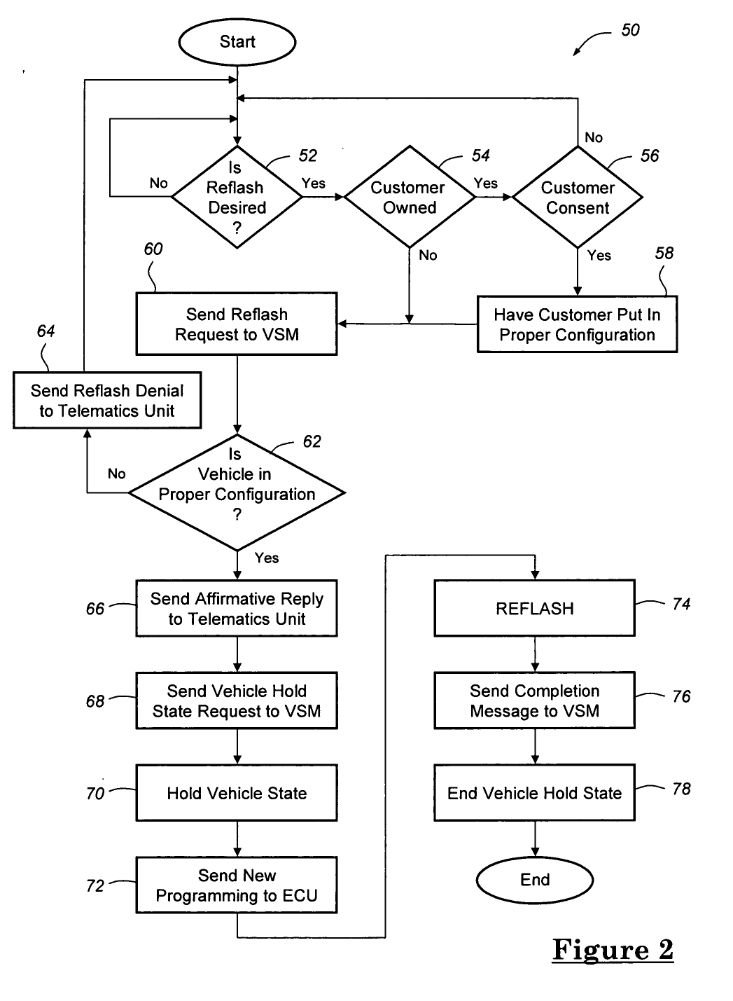

Broadly speaking, the VSM 40 has two primary functions—(1) to perform a vehicle configuration that determines whether the vehicle is in a proper configuration or state for reprogramming, and (2) to maintain at least some controllable vehicle conditions in their desired state during the reprogramming operation. Referring now to FIG. 2, there is shown one particular embodiment 50 of a remote flash memory reprogramming method of the present invention in which the telematics unit 22 and BCM 36 work together using the VSM 40 to control reprogramming of a flash memory in a third ECU such as ECU #3. In the process of FIG. 2, steps 52-60, 68, 72, and 76 are carried out by programming in the telematics unit 22 and steps 62-66,70, and 78 are carried out by the VSM 40. Following start of the process, a check 52 is first made to determine whether reprogramming of a particular flash memory is desired. If not, nothing additional is done. Once new programming is received or there is otherwise an indication that reflashing of the memory is desired for one or more particular ECUs, a check 54 is made to determine the vehicle ownership status. Thus, for example, if the vehicle has not yet been sold by the manufacturer or dealer, then the process can move on to step 58 to attempt reprogramming which can, if desired, include the involvement of a service technician who can put the vehicle in a desired configuration before proceeding. However, if the vehicle has been transferred to a subsequent owner, then consent from the owner is requested and a second check 56 is made to determine if that consent has been given. This requested consent and confirmation of such can be done via user interface 32 or by some other means of contemporaneous communication with the operator. If consent has not been given, the process returns to step 52 until a new request for reflashing is received. If owner consent is obtained, then the system utilizes the user interface 32 to provide information and instructions to the owner/operator so that the vehicle will be placed into the proper configuration for reprogramming (step 58). The information can include a brief explanation of the process (e.g., when and how long) and the need to maintain particular vehicle conditions during the process (e.g., vehicle in park). Instructions can be used to have the operator place the vehicle in the desired configuration (e.g., vehicle in park with engine off). This information and instructions can be provided via a textual display or by synthesized or pre-recorded speech played over the speaker 26, and pushbutton 30 can be used to receive responses from the operator, for example, acknowledging receipt of the information and instructions and authorizing the reprogramming process to continue. This pushbutton 30 can also be used to indicate back to the system that the operator has finished putting the vehicle in the desired configuration. In addition to or in lieu of using the pushbutton 30, the microphone 28 can be used to receive voice inputs from the operator with a suitable speech processor used to analyze the voice input. Alternatively, the consent and/or configuration of vehicle conditions by the operator can be handled with a remote call center such as the central facility 16 either with an automated voice system or using a live advisor who guides the operator through the configuration process.

Once the vehicle has been placed in the proper configuration, the process moves to step 60 where a reflash request is sent by the telematics unit 22 to the vehicle state manager 40. VSM 40 then performs a check 62 to determine whether the vehicle is, in fact, in the proper configuration. This can include a check of not only those vehicle conditions over which the VSM 40 will maintain control during reprogramming, but also can include such things as battery state of charge and/or a vehicle diagnostics check, as discussed in U.S. Patent Application Publication No. 2005/0256614A1. Also, since the desired vehicle conditions can be different for reprogramming of one ECU versus another, this check can be specific to a particular ECU, and the specific required conditions for that ECU can either be previously stored on the vehicle or can be included along with the new programming received by the vehicle. In response to this check at step 62, a vehicle status message is returned indicating whether or not the vehicle is in the proper configuration. Thus, if the proper vehicle configuration does not currently exist, a denial message is returned to the telematics unit 22 at step 64 and the process begins over. If the proper vehicle conditions do exist, then an affirmative reply is sent 66 to the telematics unit which responds with a vehicle hold state request 68. Upon receiving this request, VSM 40 initiates a vehicle hold state 70 in which at least some controllable vehicle conditions are held in a certain state or within a certain range, as appropriate. Once the hold state has been initiated, the new programming is sent 72 by the telematics unit to ECU #3 that is undergoing reprogramming, although this step can be performed earlier and/or the programming can be passed through to ECU #3 via another route. ECU #3 is then reflashed 74 and, once completed, the telematics unit sends a completion message to VSM 40 at step 76, following which VSM 40 ends its hold state 78. The vehicle can then be operated normally with its newly programmed ECU #3. As will be appreciated, this reflash process can be used to reprogram more than one ECU at a time or can be repeated sequentially for each ECU to be programmed.

There are a number of different types of actions that can be taken by the VSM 40 in implementing the vehicle hold state. For example, in terms of controllable vehicle conditions, VSM 40 can, for example, activate the ignition relay 44 and take over control of the power mode, ignoring certain vehicle or operator inputs such as ignition key switch position, transmission of a remote start signal, vehicle headlight switch position, valet key use, etc. VSM 40 can also, for example, take over control of the VLAN 34, inhibiting other uses of it that might conflict with the reprogramming operation.

When the reprogramming process is being used in conjunction with a vehicle that is no longer owned by the manufacturer or that is otherwise now subject to being driven, the user interface 32 can be used as discussed above to provide information and instructions to the operator. This can include determining an appropriate time to reprogram since the VSM 40 prevents vehicle operation during the reprogramming operation. Then, the operator can place the vehicle in the desired configuration for subsequent reprogramming. As a part of having the vehicle placed into a proper configuration (step 58), the VSM 40 can do a partial check of vehicle conditions that are not typically controlled by the operator (e.g., battery state of charge) and only request that the vehicle be put into the proper configuration by the operator if the other vehicle conditions are suitable for reprogramming. This can be done as a part of step 58 or as early as the step 52 in the process.

As will be appreciated, in this embodiment, a first ECU (i.e., ECU #3) is reprogrammed via a process that involves a second ECU (telematics unit 22), a third ECU (BCM 36), and, where driver interaction is required or desired, a fourth ECU (user interface 32). In accordance with other embodiments, the reprogramming process can be spread over more or less ECUs so that, for example, the telematics unit 22 and user interface 32 and/or BCM 36 could all be integrated into a single ECU or, where control of vehicle conditions is not required or desired during reprogramming, then the process could be implemented by telematics unit 22 alone or by some other single or multiple configuration of ECUs. The structure and operation of all such variations will be apparent to those skilled in the art.

It is to be understood that the foregoing description is not a description of the invention itself, but of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, although the illustrated embodiment has been discussed in conjunction reprogramming of flash memory, the disclosed system and method can be used with other types of firmware and with other non-volatile computer-readable memory in general. Furthermore, although the described embodiment is directed to use of the vehicle state manager in conjunction with new programming received wirelessly, it can also be used to control reprogramming of memory using new programming that is provided to the vehicle from a hardwired computer or other tool such as would be used at a service facility. In such an arrangement, telematics unit 22 may not be needed at all. These and other embodiments, changes, and modifications are intended to come within the scope of the appended claims.

As used in this specification and claims, the terms “for example” and “such as,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A method of reprogramming firmware in a first electronic control unit (ECU) located onboard a vehicle using new programming supplied to the vehicle, the method comprising the steps of:
(a) receiving new programming via wireless transmission to the vehicle using a second ECU located onboard the vehicle;
(b) determining whether vehicle conditions are acceptable for reprogramming of the first ECU; and
(c) if the vehicle conditions are acceptable, then sending the new programming to the first ECU and storing the new programming in firmware contained in the first ECU while holding certain vehicle conditions in their existing state.

2. The method of claim 1, wherein step (c) is carried out using a vehicle state manager program executing in a third ECU.

3. The method of claim 2, wherein the third ECU operates on the vehicle as a power mode master.

4. The method of claim 3, wherein the third ECU is operable under control of the vehicle state manager to ignore user inputs via an ignition key switch during reprogramming of the first ECU.

5. The method of claim 4, wherein step (c) further comprises maintaining the ignition in a predetermined state independently of ignition key switch position during storing of the new programming in the first ECU.

6. The method of claim 2, wherein step (b) is carried out under control of the vehicle state manager.

7. The method of claim 2, wherein step (b) further comprises the following steps:
(b1) sending a reprogramming request from the second ECU to the third ECU;
(b2) checking the state of different vehicle conditions using the third ECU;
(b3) sending a vehicle status message from the third ECU to the second ECU; and
wherein step (c) further comprises determining if the vehicle status message indicates that the vehicle conditions are acceptable for reprogramming of the first ECU and, if so, then:
(c1) sending a vehicle hold state request to the third ECU;
(c2) executing the vehicle hold state using the third ECU under control of the vehicle state manager program;
(c3) storing the new programming in the firmware;
(c4) sending a completion message to the second ECU and terminating the vehicle hold state.

8. The method of claim 1, further comprising carrying out prior to step (b) the step of interacting with a vehicle operator via a user interface and instructing the vehicle operator to place the vehicle in the desired configuration.

9. The method of claim 8, wherein said interacting step further comprises using voice instructions to interact with the vehicle operator.

10. A method of reprogramming flash memory located in an electronic control unit onboard a vehicle using new programming supplied wirelessly from a remote location, the vehicle having a telematics unit that is coupled to the electronic control unit and that receives the new programming via a wireless communications network, the method comprising the steps of:
(a) receiving new programming for the electronic control unit via wireless transmission from the wireless communications network to the vehicle's telematics unit;
(b) determining if a desired configuration of vehicle conditions exists on the vehicle;
(c) if the desired configuration exists, then carrying out a reprogramming process that includes:
(c1) initiating a vehicle state hold by maintaining at least some controllable vehicle conditions in their current state and inhibiting changes to those controllable vehicle conditions until the reprogramming process is complete;
(c2) sending the new programming to the electronic control unit; and
(c3) replacing programming within the electronic control unit with the new programming; and thereafter
(d) terminating the vehicle state hold.

11. The method of claim 10, wherein step (b) further comprises checking the state of different vehicle conditions for the existence of the desired configuration.

12. The method of claim 10, wherein step (b) further comprises interacting with a vehicle operator via a user interface and instructing the vehicle operator to place the vehicle in the desired configuration, and thereafter checking the state of the vehicle conditions to confirm that the desired configuration exists.

13. The method of claim 10, wherein step (b) further comprises determining if at least the following two vehicle conditions exist:
i. vehicle battery state of charge is above a minimum; and
ii. vehicle engine is off.

14. A method of reprogramming flash memory located in an electronic control unit onboard a vehicle using new programming supplied to the vehicle, the method comprising the steps of:
(a) interacting with a vehicle operator via a user interface and instructing the vehicle operator to place the vehicle in a desired configuration;
(b) placing the vehicle in a vehicle hold state by electronically inhibiting changes to the desired configuration;
(c) storing new programming in flash memory contained in at least one vehicle electronic control unit; and thereafter (d) removing the vehicle from the vehicle hold state and thereby permitting the vehicle configuration to be changed from the desired configuration.

15. The method of claim 14, wherein step (a) further comprises interacting with the vehicle operator using voice instructions given by the user interface and voice commands received from the vehicle operator.

16. The method of claim 14, wherein at least steps (b) and (d) are carried out using a vehicle state manager program executing in an electronic control unit located onboard the vehicle.
